(19) United States
(12) Patent Application Publication
(10) Pub. No.: US 2014/0164623 A1
(43) Pub. Date: Jun. 12, 2014

(54) METHOD AND A SYSTEM FOR MANAGING RESOURCE ALLOCATION IN SCALABLE DEPLOYMENTS

(71) Applicants: Fermín Galán, Madrid (ES); Ignacio Blasco, Madrid (ES); Daniel Morán, Madrid (ES); Jesús Bernat, Madrid (ES)

(72) Inventors: Fermín Galán, Madrid (ES); Ignacio Blasco, Madrid (ES); Daniel Morán, Madrid (ES); Jesús Bernat, Madrid (ES)

(73) Assignee: TELEFONICA, S.A., Madrid (ES)

(21) Appl. No.: 14/130,215

(22) PCT Filed: Jun. 26, 2012
(86) PCT No.: PCT/EP2012/062393

§ 371 Date: Jan. 28, 2014

(30) Foreign Application Priority Data
Jul. 1, 2011 (ES) P201131116

(51) Int. Cl. H04L 12/911

(52) U.S. Cl. CPC H04L 47/72
USPC 709/226

(57) ABSTRACT

A method and a system for managing resource allocation in scalable deployments

The method of the invention takes into account the accumulated cost saving of resources (in the past) to extend the limit of resources that can be allocated in said scalable deployments according to current dependence on resources.

The system is arranged for implementing the method of the present invention.

### FIELD OF THE ART

The present invention generally relates to a method for managing resource allocation in scalable deployments, said scalable deployments implementing automatic elasticity and having a limit of resources which can be allocated in and more particularly to a method that takes into account the accumulated cost saving (in the past) to extend said limit according to current dependence on resources.

A second aspect of the invention relates to a system arranged for implementing the method of the first aspect.

### PRIOR STATE OF THE ART

Cloud computing approaches [1] allow adjusting the allocated resources to customers (typically, compute power, storage and network) according to the current utilization demand of their services. Automatic elasticity (seen as one of the “killer applications” of cloud computing) consists of automatically adding or subtracting the aforementioned resources to services deployed in the cloud without any human intervention based on the demand [2].

For example, a given company develops a new online-shopping service. When launching the service, the company may have an estimate of the resources needed but the real use can vary over the time (for example during the first weeks just few users could use it, and later start increasing in a lineal way) and even the use may change depending on the hours of the day (for example the peak time could be 6 to 10 pm. while from 2 to 6 am is barely used) or the days of the week (for example it could be more used on week days than on weekends). Since a priori is difficult to accurately estimate the real demand of resources in a given period of time, automatic scaling is one of the most important features that a cloud service should provide.

Resources consumed in cloud computing are usually billed using pay-per-use models [1] or combined models (fix rate plus pay-per-use). The pay-per-use cost component involves an economical risk for customers when combined with automatic elasticity due to the resources can scale up beyond customer acceptable payment threshold. This can be due to normal operation (e.g. the service is amazingly successful) or malicious attacks (Economic Denial of Service, EDoS [3]). Therefore, these systems need to include a way of specifying an upper limit (in terms of cost or resource quantity) to cape automatic scaling up actions. Of course, if service demand needs more resources than the limit, the service quality of service/experience is negatively affected.

Proposal [4] describes a cloud management system able to allocate idle nodes to batch tasks in a grid way. However, it doesn't address cost saving based elasticity/allocation. Another proposal [5] describes a mechanism for pricing for QoS reservations in networks. Same as [4], elasticity/allocation based on cost savings is not addressed.

The problem in today systems implementing automatic elasticity with cost/resource capping is that they don't take into account the accumulated cost saving. Cost capping is constant along time (or a function of time but independent of accumulated cost saving). Thus, the saved cost when resources are below the limit is not taken into account to allow raising resource allocation in periods when needed resources are beyond the nominal limit.

An example is provided to clarify this point. A given customer deploys a service in the cloud and states that she/he doesn't want to expend more than (average) 28 [symbol] per week (considering the cost of 1 resource unit per day=1 [symbol] ; a resource unit being any scalable resource such as virtual machines). Equally distributed along a week, that means a limit of 4 resource units per day.

Considering that on Monday and Tuesday of a given week, service demand is so that 2 resource units are consumed on Monday and 3 on Tuesday, that implies a cost of 5 [symbol] , so there is a saving of 3 [symbol] (corresponding to the 8 [symbol] associated to maximum use of resource, i.e. 4 resource units each day). On Wednesday, service demand increases. The scalability system determines that 5 resource units should be allocated, but this goes beyond the limit, so 4 resource units are allocated. Note that in this situation, the customer has saved 3 [symbol] the previous days, that could be used to pay for the exceeding resource unit, but the system is unaware of this. Of course, the difference between what service demands and what the cloud is able to provide implies degradation of the quality of service (impoverishing the user experience).

### DESCRIPTION OF THE INVENTION

It is necessary to offer an alternative to the state of the art which covers the gaps found therein, particularly related to the lack of proposals which improves the flexibility of the scalable systems that are based on fixed capping to limit the growing of resources allocated to services or users.

To that end, the present invention provides, in a first aspect a method for managing resource allocation in scalable deployments, said scalable deployments implementing automatic elasticity and having a limit of resources which can be allocated in.

On contrary to the known proposals, the method of the invention, in a characteristic manner, comprises varying said limit for a given period of time according at least to a resource saving occurred at a previous period of time, wherein said resource saving refers to a resource consumption below an initial value of said limit.

Other embodiments of the method of the first aspect of the invention are described according to appended claims 2 to 16, and in a subsequent section related to the detailed description of several embodiments.

A second aspect of the invention concerns to a system for managing resource allocation in scalable deployments, said scalable deployments implementing automatic elasticity and having a limit of resources which can be allocated in.

The system of the second aspect of the invention, on contrary to the known systems mentioned in the prior state of the art section, and in a characteristic manner, it comprises a resource allocation unit responsible of varying said limit for a given period of time according at least to a resource saving occurred at a previous period of time, wherein said resource saving refers to a resource consumption below an initial value of said limit.

The system of the second aspect of the invention is adapted to implement the method of the first aspect.

Other embodiments of the system of the second aspect of the invention are described according to appended claims 17 to 25, and in a subsequent section related to the detailed description of several embodiments.

### BRIEF DESCRIPTION OF THE DRAWINGS

The previous and other advantages and features will be more fully understood from the following detailed description of embodiments, with reference to the attached drawings (some of which have already been described in the Prior State of the Art section), which must be considered in an illustrative and non-limiting manner, in which:

FIG. 1 shows a diagram of the example provided in the Prior State of the Art section, wherein the previous cost saving is not taken into account when some resources above the limit are needed.

FIG. 2 shows the extension of the limit of resources that can be allocated to a given service or user as a result of a previous resource saving, according to an embodiment of the present invention.

FIG. 3 shows the architecture of the system proposed in the present invention.

FIG. 4 shows the algorithm to be followed in order to consolidate savings for a given service or user, according to an embodiment of the present invention.

FIG. 5 shows the algorithm to be followed in order to adjust the resources assigned to a given service or user, according to an embodiment of the present invention.

FIG. 6 shows the algorithm to be followed in order to remove resources from a given service or user, according to an embodiment of the present invention.

FIG. 7 shows a timeline of the execution of the system, according to an embodiment of the present invention.

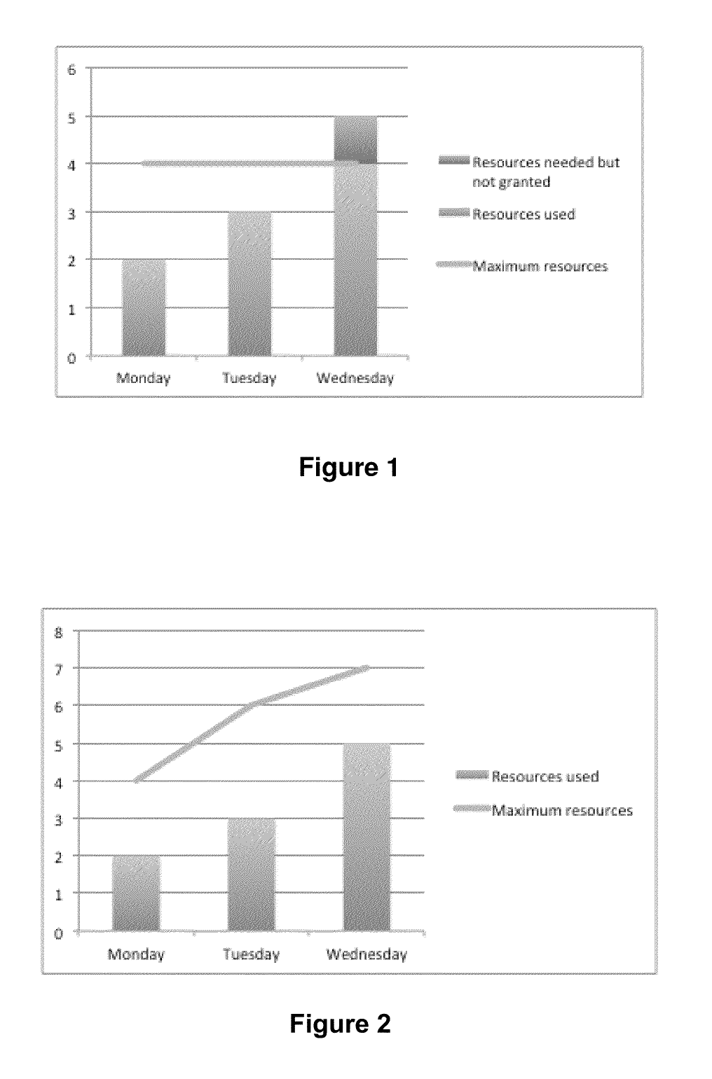

### DETAILED DESCRIPTION OF SEVERAL EMBODIMENTS

Basically, the present invention consists in a scalability system that takes into account the accumulated cost saving (in the past) to extend scalability limit according to current dependence on resources (in the present) so quality of service/experience is not impacted in that situation. The present invention has been developed in the context of cloud computing platform, but it is applicable in general to any system managing scalable resources and implementing automatic scalability.

The basic idea is to record the accumulated saving (saving pool), so that the time that resources are below the nominal limit the saving pool increases and the time that resource are above the nominal limit the saving pool decreases. When saving pool is 0, the resources allocated cannot go beyond the limit (if they are above the limit in the moment that the saving pool returns to 0, then the system removes all the resource amount beyond the limit).

Considering the example explained before, saving pool is 3 [symbol] on Wednesday, so 5 resources are allocated on Wednesday and the difference between allocation and limit (i.e. 1 resources) is subtracted from the saving pool (1 [symbol] ). Consequently, quality of service/experience is not impacted (service users are satisfied) and the customer is not exceeding her/his affordable cost limit (in fact, saving pool is 2 [symbol] for Thursday and next days), as shown in FIG. 2.

The examples above are based on daily periods, but the period could be any other in order to improve accuracy (e.g. hour, minutes, as small as technically possible, e.g. monitoring sampling rate). Note that it is out of the scope of the invention:
The mechanism used by the system to determine service demand (e.g. monitoring)
The mechanism used by the system to determine how many resources are needed for a given service demand, i.e. how many resources add/subtract in a given moment.
The mechanism that actually implements the scalability action, e.g. creation/removal of virtual machines.

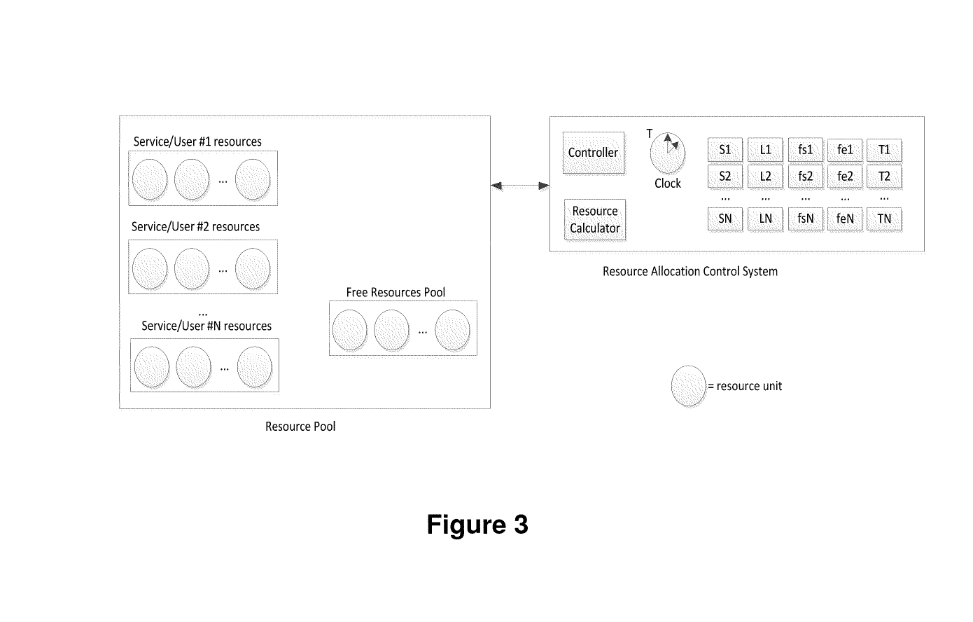

As shown in FIG. 3, the present invention is based on the Resource Allocation Control System. More specifically, the system is controlling a pool of resources. Although the resources could be heterogeneous (CPU, VM, disks, etc.) the particular resource type is not relevant as far as the pool can be split in homogenous “resource units”. In a given moment in time, some resources from the pool are allocated to different user/services and the rest conform the Free Resources Pool. The Resource Allocation Control System in which our invention is based is able to assign resources from the Free Resources Pool to user/services; and the opposite, that is, moving back the unallocated resources assigned to users/services to the Free Resources Pool.

The Resource Allocation Control System is composed of the following modules, as shown in FIG. 3:
Controller. This module implements the different methods described as part of the invention below.
Resource Calculator. This module analyzes the optimal amount of resource units for each one of the different services/users and provides this input to the Controller, typically in the form of events. How this calculation is done is not within the scope of the invention.
Clock. Used by the Controller modules to coordinate actions.

In addition, the Resource Allocation Control System uses the following pieces of information for each one of the N users/services managed in a given instant. How they are initially configured (e.g. a GUI) and internally stored (e.g. database or any other mechanism) is out of the scope of the invention.
Saving pool (S). Accumulated saving amount (in resource units per period). It is initialized with a given value (including 0). It is increased and decreased according to the methods described as part of the invention below.
Saving Period (T). Time period to accumulate saving. It can be as small as technically possible.
Average Limit (L). The maximum resource consumption limit (in resource units) in a given period when Saving Pool is 0. It can be constant or time dependent (e.g. based on a weekly pattern), but locally constant during T .
Saving correction factor (fₛ). A corrector factor to be applied in the calculation involving accumulating savings for unsused resources, e.g. just a 75% (for a fₛ=0.75) of the not used resources could be saved. It can be constant or time dependent (e.g. based on a weekly pattern), but locally constant during T. It is required that fₛ>0, wherein the default value is fₛ=1.
Expending correction factor (fₑ). A corrector factor to be applied in the calculation involving resource consumption, e.g. considering that the client is using additional saved resources in the peak time of the infrastructure, the extra resources needed will be charged to a 25% extra (for a fₑ=1.25). It can be constant or time dependent (e.g. based on a weekly pattern), but locally constant during T. It is required that fₑ>0, the default value is fₑ=1.

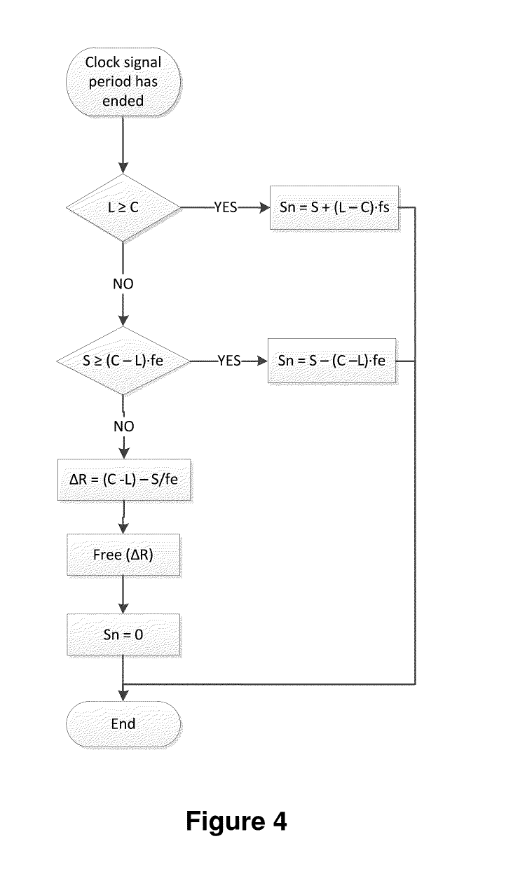

The Controller implements several methods, described below:
Consolidate saving for a given service/user, as shown in FIG. 4.

1. The Clock signals that the period has ended.

2. The Controller calculates the difference between the current allocated resource units (C units) and the average limit (L):

L≧C
Increase the saving pool value, so the new value (Sₙ):

Sₙ=S+(L−C)·fₛ

L<C
If S≧(C−L)·fe, then the saving pool can support resource utilization exceeding the limit. That is, decrease the saving pool, so the new value:

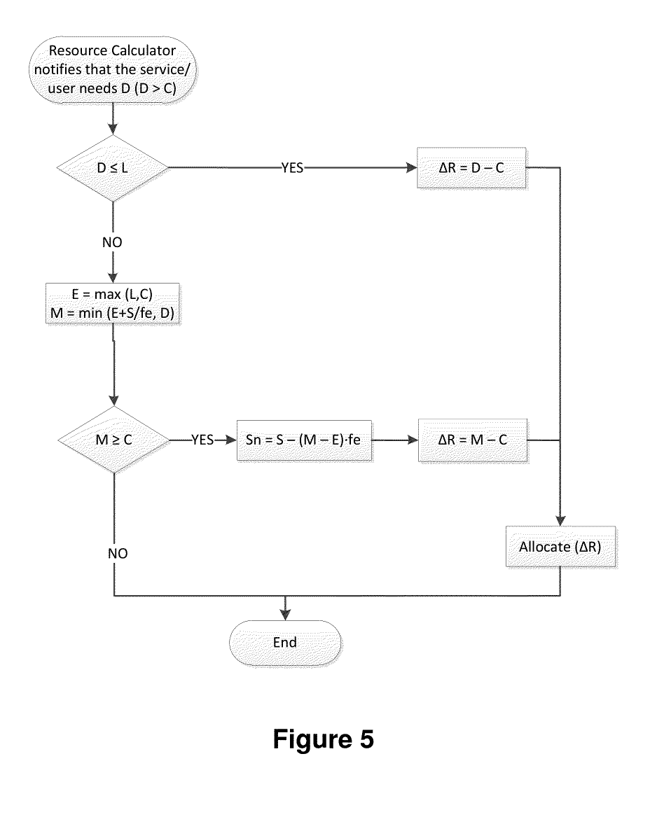

Sₙ=S−(C−L)·fₑ.
Note that the inequality at the beginning of the paragraph ensures that Sn≧0.
If S<(C−L)·fe, the saving pool is depleted and the exceeding resources need to be freed. So:
   Calculate resource units to release, as ΔR=(C−L)−S/fₑ (note that the inequality at the beginning of this paragraph ensures that this amount is positive).
   Free ΔR, i.e. moving them from the given service/user to the Free Resources Pool. The particular resource freeing procedure is out of the scope of the invention.
   Make Sₙ=0
Adjust resources to a given service/user, as shown in FIG. 5.

1. The Resource Calculator notifies that the service/user needs a given amount of resources (D units), greater than the current allocated units (C units).
1.1. If D≦L

Calculate the resources to add, ΔR=D−C

Allocate ΔR resource units, i.e. moving them from Free Resources Pool to the given service/user. The particular resource allocation procedure is out of the scope of the invention.
1.2. If D>L

Let E be the resource value that when passed produces saving expending, that is the greater between the limit or the current resources, so E=max (L, C)

Let M be the maximum allowed resources, either D or the value that would deplete the saving pool (E+S/fe), so M=min (E+S/fe, D).

If M>C
Decrease saving pool, so the new value: Sₙ=S−(M−E)·fₑ
Calculate the resources to add, ΔR=M−C
Allocate ΔR resource units, i.e. moving them from Free Resources Pool to the given service/user. The particular resource allocation procedure is out of the scope of the invention.

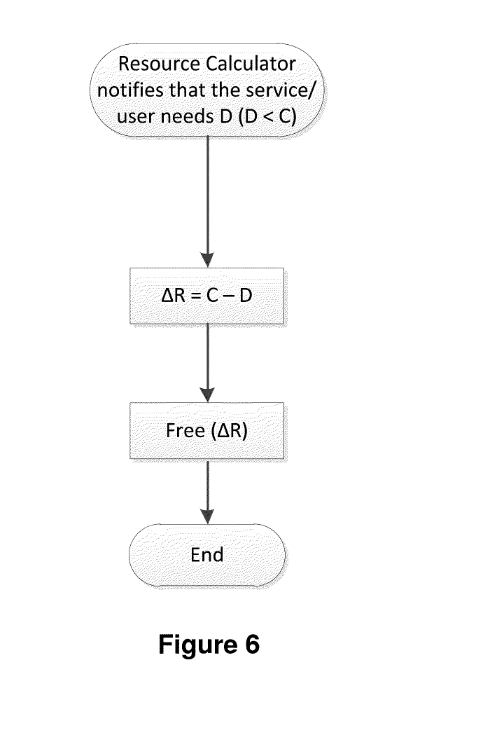

If M<C
Nothing is done in this case
Remove resources from a given service/user, as shown in FIG. 6.

1. The Resource Calculator notifies that the service/user needs a given amount of resources (D units), lesser than the current allocated units (C units). Being ΔR=C−D.

2.Free ΔR, i.e. moving them from the given service/user to the Free Resources Pool. The particular resource freeing procedure is out of the scope of the invention. Note that the service/user is not getting any “payback” for freeing resources. In order to avoid unfairness two alternatives are possible:
Make T as small as the possible unfairness is negligible. That is, T→dt.
Apply the “Remove resources from a given service/user” only at period ends (that is, synchronously just before to the “Consolidate saving for a given service/user” method).

The Controller executes the different methods in the following way:
Controller executes “Consolidate saving for a given service/user” synchronously (at the end of T period).
Controller executes “Adjust resources to a given service/user” asynchronously (when the Resource Calculator detects lack of resources).
Controller executes “Remove resources from a given service/user” either synchronously (at the end of T period, just before “Consolidate saving for a given service/user”) or asynchronously (when the Resource Calculator detects exceed of resources).

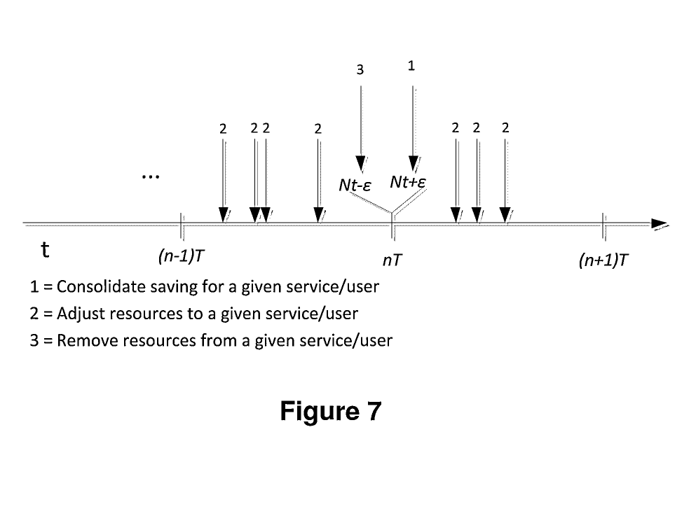

In FIG. 7 it was shown an example timeline based on the former case for a given service/user (there would be a different timeline for each service/user, not necessarily synchronized between them). In the example, new resources are being added as soon as the Resource Calculator detects that are needed (2). But the procedure for calculating the savings (“Consolidate saving for a given user/service”) and the removal of resources (“Remove resources from a given service/user”) are executed at predetermined periodic time (multiples of T).

In a possible embodiment of the present invention, the resource pool managed by the system is a pool of computing resources (CPU, RAM, etc.) encapsulated and provided as virtual machines supported by a set of physical hypervisors. The resource type is virtual machines although the list of resources could also refer to elements not provided by virtual machines, such as network resources.

The different elements in the Resource Allocation System are implemented as follows:
The Controller is implemented using a Business Rule Engine. In particular the drools engine [6] is being used. The rules governing the behaviour of the system and implementing the different methods are encoded in RIF [7] (attached to the service definition in OVF [8] at service deployment time) then encoded to drools internal language.
The Resource Calculator is implemented by a system that monitors continuously the end-to-end transaction delay of the services. If the delay goes up a given scaling up threshold for a while the system considers that the demand is too high and at least one virtual machine has to be added. In the opposite, if the delay goes back under a given scaling down threshold for a while, then the system considers that the demand is too low and at least one virtual machine is not needed. Note that the thresholds for scaling up and the one for scaling down are not necessarily the same (in fact, it is not usual).
The system parameters (limit, saving pool, etc.) are stored in the knowledge base used by the business rule engine which implements the Controller. The time period (T) is one hour. The average limit value can vary from hour to hour in order to implement hourly service demand patterns (e.g. higher during business hours). The saving correction factor and expending correction factor are both equal to 1.

The allocation procedure is based on create new virtual machines in the physical hypervisors (and eventually reconfigure the Load Balancers (LB) which dispatch traffic to those virtual machines, in order to add the new one to the LB management pool). In the opposite, the freeing procedure is based on removing one of the virtual machines based on some heuristic procedure, e.g. the less loaded virtual machine, the one with the less number of active connections, etc. (and eventually reconfigures the LB which dispatches traffic to those virtual machines, in order to remove the removed machine to the LB management pool).

### ADVANTAGES OF THE INVENTION

The invention improves the flexibility of the state-of-the-art elasticity mechanisms which are based on fixed capping to limit the growing of resources allocated to service/users. Using the present invention, that limit is not rigid, but flexible and dependant of the accumulated cost saving. Note that in the fixed approach, this cost saving is lost: using the present invention this cost saving is used to raise the limit so the elasticity is more capable of following service demand and avoid situations in which resources are needed but cannot be granted. In this sense, service deployed in a cloud based on our invention will perform more efficiently without breaking the expense limits specified by the customer.

A person skilled in the art could introduce changes and modifications in the embodiments described without departing from the scope of the invention as it is defined in the attached claims.

### ACRONYMS

EDoS Economic Denial of Service
GUI Graphical User Interface
LB Load Balancer
OVF Open Virtualization Format
QoS Quality of Service
RIF Rule Interchange Format

### REFERENCES

[1] Luis M. Vaquero, Luis Rodero-Merino, Juan Caceres, Maik Lindner, “A Break in the Clouds: Towards a Cloud Definition”, ACM SIGCOMM Computer Communication Review, vol. 39(1), pp. 50-55, January 2009.

[2] Luis Rodero-Merino, Luis M. Vaquero, Victor Gil, Javier Fontan, Fermin Galan, Ruben S. Montero, Ignacio M. Llorente, “From Infrastructure Delivery to Service Management in Clouds”, Future Generation Computer Systems, special issue on Federated Resource Management in Grid and Cloud Computing Systems, vol. 26(8), pp. 1226-1240, October 2010.

[3] “Cloud Computing Security: From DDoS (Distributed Denial Of Service) to EDoS (Economic Denial of Sustainability)”, November 2008. http://rationalsecurity.typepad.com/blog/2008/11/cloud-computing-security-from-ddos-distributed-denial-of-service-to-edos-economic-denial-of-sustaina.html
[4] “Method, System and Computer Program Products for a Cloud Computing Sport Market Platform”, US20100088205A1, April 2010.
[5] “A System for Pricing-based Quality of Service (PQoS) Control in Networks”, WO2001058084A2, August 2001.

[6] Drools, http://www.jboss.org/drools
[7] Rule Interchange Format, W3C Std., 2005. http://www.w3.org/2005/rules/[8]
[8] Open Virtualization Format (OVF). Specification DSP0243 1.1.0, Distributed Management Task Force (DMTF), January 2010.

1. A method for managing resource allocation in scalable deployments, said scalable deployments implementing automatic elasticity and having a limit of resources which can be allocated in, the method comprises varying said limit for a given period of time according at least to a resource saving occurred at a previous period of time, wherein said resource saving refers to a resource consumption below an initial value of said limit.

2. A method as per claim 1, wherein said resource consumption is performed by a user or a service.

3. A method as per claim 1, wherein said resource saving is the difference between said initial value of said limit and said resource consumption

4. A method as per claim 1, comprising increasing said limit when occurring said resource saving at a said previous period of time, considering also a saving correction factor.

5. A method as per claim 1, comprising decreasing said limit when said resource consumption is above said initial value of said limit.

6. A method as per claim 1, comprising quantifying said resource consumption and said resource saving by means of resource units.

7. A method as per claim 6, comprising storing said resource saving of each period of time in a saving pool whose value indicates the accumulated saving amount of said resource units.

8. A method as per claim 7, comprising calculating said value of said saving pool for the next period of time, when said resource consumption is below or equal to said initial value of said limit, as:
SₙS+(L−C)·fₛ
where
Sₙ is said value of said saving pool
S is the current value of said saving pool;
L is said initial value of said limit;
C is said resource consumption; and
fₛ is a correction factor greater than 0.

9. A method as per claim 8, comprising calculating said value of said saving pool for the next period of time, when said resource consumption is above said initial value of said limit and the condition S>(C−L)·fₑ is satisfied, as:
Sₙ=S−(C−L)·fₑ
where fₑ is an expending corrector factor greater than 0.

10. A method as per claim 9, comprising releasing at least part of said resource units consumed by said service or user and making Sₙ equal to 0 when said resource consumption is above said initial value of said limit and the condition S<(C−L)·fₑ is satisfied.

11. A method as per claim 10, wherein the number of said at least part of said resource units consumed by said service or user is determined by the following expression:
ΔR=(C−L)−S/fₑ

12. A method as per claim 7, comprising adding a certain number of resource units to the current allocated resource units for a given service or user when said service or user requires a greater amount of said resource units than said current allocated resource units, being said greater amount below said limit, wherein said number is determined by:
ΔR=(D−C)
where
D is said amount of said resource units required by said service or user; and
C is said current allocated resource units.

13. A method as per claim 12, comprising decreasing said value of said saving pool for the next period of time when said service or user requires a greater amount of said resource units than said current allocated resource units if the condition M≧C is satisfied, being said greater amount above said limit, according to the following expression:
Sₙ=S−(M−E)·fₑ
where
Sₙ is said value of said saving pool
S is the current value of said saving pool;
E=max(L, C), max calculates the maximum value;
M=min(E+S/fₑ, D), min calculates the minimum value;
L is said initial value of said limit;
fₑ is a expending corrector factor greater than 0.

14. A method as per claim 13, comprising adding a certain number of resource units to the current allocated resource units for a given service or user said certain number being determined by:
ΔR=(M−C)

15. A method as per claim 7, comprising removing a certain number of resource units to the current allocated resource units for a given user or service when said service or user requires a lesser amount of said resource units than said current allocated resource units, said certain number being determined by:
ΔR=(C−D)
where
C is said current allocated resource units; and
D is said amount of said resource units required by said service or user.

16. A system for managing resource allocation in scalable deployments, said scalable deployments implementing automatic elasticity and having a limit of resources which can be allocated in, characterised in that it comprises a resource allocation control system responsible of varying said limit for a given period of time according at least to a resource saving occurred at a previous period of time, wherein said resource saving refers to a resource consumption below an initial value of said limit.

17. A system as per claim 16, wherein said resource consumption and said resource saving are quantified by means of resource units.

18. A system as per claim 17, wherein a saving pool stores said resource saving of each period of time, and a saving value of said saving pool indicates the accumulated saving amount of said resource units

19. A system as per claim 18, wherein a resources pool managed by said resource allocation control system stores the number of resource units allocated for a given service or user and a free resources pool stores the resources of said scalable deployment that are not being used.

20. A system as per claim 19, wherein said resource allocation control system at least comprises:
a controller that determines the number of said resource units to be stored in said saving pool, said resources pool and said free resources pool;
a resource calculator that provides to said controller the optimal number of said resource units to be allocated for a given user or service; and
a clock that is used to coordinate different operations of said resource allocation control system.

21. A system as per claim 20, wherein said controller executes at least one of the following instructions:
consolidate saving for a given service or user;
adjust resources to a given service or user; and
remove resources from a given service or user

22. A system as per claim 21, wherein said consolidate saving for a given service or user instruction is executed synchronously at the end of a period of said clock.

23. A system as per claim 21, wherein said adjust resources to a given service or user instruction is executed asynchronously.

24. A system as per claim 21, wherein said remove resources from a given service or user instruction is executed either synchronously at the end of a period of said clock and before said consolidate saving for a given service or user instruction, or asynchronously.
